(19) United States
(12) Patent Application Publication
(10) Pub. No.: US 2017/0253834 A1
(43) Pub. Date: Sep. 7, 2017

(54) USE OF CATIONIC POLYMERS FOR IMPROVING SUDSING PROFILE OF LAUNDRY DETERGENT COMPOSITIONS

(71) Applicant: The Procter & Gamble Company, Cincinnati, OH (US)

(72) Inventors: Gang SI, Beijing (CN); Mark Robert SIVIK, Cincinnati, OH (US); Stefano SCIALLA, Strombeek-Bever (BE); Qi ZHANG, Beijing (CN); Jin LI, Beijing (CN); Aaron FLORES-FIGUEROA, Mannheim (DE); Christine MENDERA, Dannstadt-Schauernheim (DE); Hui GE, Shanghai (CN)

(21) Appl. No.: 15/446,021

(22) Filed: Mar. 1, 2017

(30) Foreign Application Priority Data
Mar. 4, 2016 (WO) CN2016/075572

(51) Int. Cl. C11D 3/00; C11D 3/37; C11D 1/22; C08F 220/56; C11D 1/66; C11D 1/29; C08F 236/20; C11D 11/00; C11D 1/75

(52) U.S. Cl. CPC C11D 3/0026; C11D 11/0017; C11D 3/3773; C11D 1/22; C11D 1/75; C11D 1/66; C11D 1/29; C08F 236/20; C08F 220/56

(57) ABSTRACT

A method for improving sudsing profile of laundry detergent compositions with a cationic polymer. Related liquid detergent compositions having a cationic polymer. The cationic polymer may be characterized by having a weight average molecular weight (Mw) ranging from 1,000 to 300,000 Daltons and by containing: (i) from 35 mol % to 85 mol % of a first, nonionic structural unit derived from (meth)acrylamide (AAm); (ii) from 10 mol % to 65 mol % of a second, cationic structural unit; and (iii) from 0.1 mol % to 35 mol % of a third, anionic structural unit derived from (meth)acrylic acid (AA) or anhydride thereof, while the total mol % of (i)-(iii) adds up to 100 mol %, and the molar ratio of (ii) to (iii) is greater than 1.

### FIELD OF THE INVENTION

The present invention relates to laundry detergent compositions, preferably liquid laundry detergent compositions designated for hand-washing fabrics.

### BACKGROUND OF THE INVENTION

Sudsing profile is important for laundry detergents, especially those designed for hand washing fabrics, where the appropriate volume and speed of suds formation, retention and disappearance in the wash and rinse cycles are considered key benchmarks of performance by the consumers.

Consumers viewed copious suds in the wash as the primary and most desirable signal of cleaning. High suds are especially desirable during hand washing of fabrics, since the consumer can directly feel and touch the suds generated during the wash cycle and will intuitively correlates the high suds volume with effective fabric cleaning.

Paradoxically, while a large volume of suds is desirable during the wash cycle of fabric cleaning, it is nevertheless undesirable during the rinse cycle. If such high suds are still present during rinse, then the consumers immediately infer from it that there may still be surfactant residue on the fabrics and that the fabrics are not yet “clean”. As a result, the consumers feel the need to rinse the fabrics multiple times in order to make sure that the surfactants are removed as thoroughly as other soils. Because water is often a limited resource, especially in hand washing countries, the excess amount of water consumed by multiple rinses reduces the amount of water available for other uses, such as irrigation, drinking, bathing, etc.

One way to reduce rinse suds is to add a de-foaming agent during the rinse cycles. For example, PCT Publication No. WO2011/107397 (Unilever) discloses a laundry detergent composition comprising a delayed-release amino-silicone based anti-foaming agent that is absorbed onto a carrier or filler to act in the rinsing cycle to reduce or eliminate suds, preferably after two rinse cycles. However, this option is cost-prohibitive for most hand-washing consumers. Further, the suds control benefit imparted by such amino-silicone based anti-foaming agent may come at the expense of wash suds, i.e., the wash suds volume can be significantly reduced since the silicone release timing is difficult to control. Inopportune release of the silicone anti-foam may lead to significant reduction of wash suds volume, which will give consumer the impression that the detergent composition contains lower surfactant level and is therefore of lower quality/value. EP Publication No. EP0685250A1 (Dow Corning) discloses a foam control composition for use in laundry detergents that inhibits the formation of new suds during the post-wash rinsing cycles, but it does not appear to quicken the elimination of already existing suds carried over from the wash cycle.

Therefore, there is a need for a detergent composition with an improved sudsing profile characterized by both high wash suds volume and low rinse suds volume is desired by consumers of hand washing habits. Such a detergent composition can generate ample suds during the wash cycle to delight the consumers but leaves little or no suds during the rinse cycle. Particularly, it is desirable to enable strong suds formation (both fast generation of large volume of suds as well as stability or sustainability of the suds already generated over time) during the wash cycle while reducing and eliminating the suds quickly during the rinse cycle(s), preferably across a range of consumer wash habits and fabric/material surfaces being washed, so that a single rinse cycle might be sufficient to remove the suds, thereby enabling the “single rinse” concept.

### SUMMARY OF THE INVENTION

The present invention discovers that certain cationic polymers containing a (meth)acrylamide (AAm)-derived unit, a cationic monomeric unit, and an acrylic acid-derived unit at a specific monomeric ratio and having a molecular weight within a specific range can be used to improve the sudsing profile of a laundry detergent composition, by significantly reducing suds during the rinse cycle while maintaining comparable suds volume during the wash cycle.

Similar cationic polymers have previously been used in hard surface cleaners to improve cleaning of surface soil and provide anti-fog effects on hard surfaces (see US2009/0324964A). However, it is a surprising and unexpected discovery of the present invention that such cationic polymers can be used in laundry detergent compositions to improve sudsing profiles during the laundering process and enhance consumer experience, especially those consumers who hand wash their fabrics. Further, such cationic polymers have good whiteness maintenance benefit, i.e., they lead to no or little fabric whiteness loss after repeated laundering cycles.

In one aspect, the present invention relates to methods of using a cationic polymer for improving sudsing profile of a laundry detergent composition, while such cationic polymer is present in the laundering detergent composition at an amount ranging from 0.01 wt % to 15 wt %, and while such cationic polymer include: (i) from about 35 mol % to about 85 mol % of a first, nonionic structural unit derived from (meth)acrylamide (AAm); (ii) from about 10 mol % to about 65 mol % of a second, cationic structural unit; and (iii) from about 0.1 mol % to about 35 mol % of a third, anionic structural unit that is derived from (meth)acrylic acid (AA) or anhydride thereof, provided that the total mol % of (i)-(iii) adds up to 100 mol %, that the molar ratio of (ii) to (iii) is greater than 1, and that the cationic polymer is characterized by a weight average molecular weight (Mw) ranging from about 1,000 to about 300,000 Daltons.

In another aspect, the present invention relates to a liquid laundry detergent composition having a pH of equal to or greater than 7, which contains:
(1) from about 1 wt % to about 50 wt % of one or more anionic surfactants selected from the group consisting of C₁₀-C₂₀ linear alkyl benzene sulphonates, C₁₀-C₂₀ linear or branched alkylalkoxy sulfates having a weight average degree of alkoxylation ranging from 0.1 to 5.0, C₁₀-C₂₀ linear or branched alkyl sulfates, C₁₀-C₂₀ linear or branched alkyl ester sulfates, C₁₀-C₂₀ linear or branched alkyl sulphonates, C₁₀-C₂₀ linear or branched alkyl ester sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof; and
(2) from about 0.01 wt % to about 15 wt % of a cationic polymer according to the present invention.

These and other features of the present invention will become apparent to one skilled in the art upon review of the following detailed description when taken in conjunction with the appended claims.

### DETAILED DESCRIPTION OF THE INVENTION

### Definitions

As used herein, “suds” indicates a non-equilibrium dispersion of gas bubbles in a relatively smaller volume of a liquid. The terms like “suds”, “foam” and “lather” can be used interchangeably within the meaning of the present invention.

As used herein, “sudsing profile” refers to the properties of a detergent composition relating to suds character during the wash and rinse cycles. The sudsing profile of a detergent composition includes, but is not limited to, the speed of suds generation upon dissolution in the laundering liquor, the volume and retention of suds in the wash cycle, and the volume and disappearance of suds in the rinse cycle. Preferably, the sudsing profile includes the Wash Suds Index and Rinse Suds Index, as specifically defined by the testing methods disclosed hereinafter in the examples. It may further include additional suds-related parameters, such as suds stability measured during the washing cycle and the like.

As used herein, the term “cationic polymer” refers to a polymer having a net cationic or positive charge. Such polymer typically contains one or more cationic monomers. It may contain one or more anionic monomers and/or nonionic monomers in addition to the cationic monomers, but the total charge carried by all monomeric units in the polymer is positive (i.e., cationic).

As used herein, “charge density” refers to the net charge density of the polymer itself and may be different from the monomer feedstock. Charge density for a homopolymer may be calculated by dividing the number of net charges per repeating (structural) unit by the molecular weight of the repeating unit. The positive charges may be located on the backbone of the polymers and/or the side chains of polymers. For some polymers, such as those with amine structural units, the charge density depends on the pH of the carrier. For these polymers, charge density is calculated based on the charge of the monomer at pH of 7. Typically, the charge is determined with respect to the polymerized structural unit, not necessarily the parent monomer.

As used herein, the term “Cationic Charge Density” (CCD) means the amount of net positive charge present per gram of the polymer. Cationic charge density (in units of milliequivalents of charge per gram of polymer) may be calculated according to the following equation:

$$C C D = \frac{1000 \times ( E 2 \times C 2 - E 3 \times C 3 )}{C 1 \times W 1 + C 2 \times W 2 + C 3 \times W 3}$$

where: E2 is the molar equivalents of charge of the second, cationic structural unit; E3 is the molar equivalents of charge of the third, anionic structural unit; C1 is the molar percentage of the first, third nonionic structural unit; C2 is the molar percentage of the second, cationic structural unit; and C3 is the molar percentage of the third, anionic structural unit; W1, W2, and W3 are the molecular weights of the first, second, and third structural units, respectively. For example, for an AAm/DADMAC/AA polymer containing 76 mol % of AAm, 20 mol % of DADMAC, and 4 mol % of AA respectively, its cationic charge density (meq/g) is calculated as: CCD=1000×(E₂ C₂−E₃ C₃)/(C₁ W₁+C₂ W₂+C₃ W₃), wherein E₂=1, E₃=1, C₁=76, C₂=20, C₃=4, W₁=71.08, W₂=161.67, W₃=72.06. Therefore, the cationic charge density of this copolymer is CCD=1000×[(1×20)−(1×4)]/(76×71.08+20×161.67+4×72.06)=1.79.

Unless otherwise specified, the term “molecular weight” typically refers to the weight average molecular weight (“Mw”) of the polymer chains in a polymer composition, which may be calculated using the equation:

Mw=(Σi Ni Mi²)/(Σi Ni Mi)

where Ni is the number of molecules having a molecular weight Mi. The weight average molecular weight must be measured by the method described in the Test Methods section.

As used herein “mol %” refers to the relative molar percentage of a particular monomeric structural unit in a polymer. It is understood that within the meaning of the present invention, the relative molar percentages of all monomeric structural units that are present in the cationic polymer shall add up to 100 mol %.

As used herein, the term “derived from” refers to monomeric structural unit in a polymer that can be made from a compound or any derivative of such compound, i.e., with one or more substituents. Preferably, such structural unit is made directly from the compound in issue. For example, the term “structural unit derived from (meth)acrylamide” refers to monomeric structural unit in a polymer that can be made from (meth)acrylamide, or any derivative thereof with one or more substituents. Preferably, such structural unit is made directly from (meth)acrylamide. The term “(meth)acrylamide” refers to either methacrylamide or acrylamide, and it is abbreviated herein as “AAm.”

The term “ammonium salt” or “ammonium salts” as used herein refers to various compounds selected from the group consisting of ammonium chloride, ammonium fluoride, ammonium bromide, ammonium iodine, ammonium bisulfate, ammonium alkyl sulfate, ammonium dihydrogen phosphate, ammonium hydrogen alkyl phosphate, ammonium dialkyl phosphate, and the like. For example, the diallyl dimethyl ammonium salts (DADMAS) as described herein include, but are not limited to: diallyl dimethyl ammonium chloride (DADMAC), diallyl dimethyl ammonium fluoride, diallyl dimethyl ammonium bromide, diallyl dimethyl ammonium iodine, diallyl dimethyl ammonium bisulfate, diallyl dimethyl ammonium alkyl sulfate, diallyl dimethyl ammonium dihydrogen phosphate, diallyl dimethyl ammonium hydrogen alkyl phosphate, diallyl dimethyl ammonium dialkyl phosphate, and combinations thereof. Preferably but not necessarily, the ammonium salt is ammonium chloride.

As used herein, articles such as “a” and “an” when used in a claim, are understood to mean one or more of what is claimed or described.

As used herein, the terms “comprising,” “comprises,” “include”, “includes” and “including” are meant to be non-limiting. The term “consisting of” is meant to be limiting, i.e., excluding any components or ingredients that are not specifically listed except when they are present as impurities. The term “consisting essentially of,” on the other hand, allows the presence of other components or ingredients as long as they do not interfere with the functions of those components or ingredients that are specifically listed. As used herein, the term “substantially free of” or “substantially free from” refers to the presence of no more than 0.5%, preferably no more than 0.2%, and more preferably no more than 0.1%, of an indicated material in a composition, by total weight of such composition. As used herein, the term “essentially free of” means that the indicated material is not deliberately added to the composition, or preferably not present at analytically detectable levels. It is meant to include compositions whereby the indicated material is present only as an impurity of one of the other materials deliberately added.

As used herein, the term “fluid” includes liquid, gel, paste and gas product forms.

As used herein, the term “liquid” refers to a fluid having a liquid having a viscosity of from about 1 to about 2000 mPa*s at 25° C. and a shear rate of 20 sec-¹. In some embodiments, the viscosity of the liquid may be in the range of from about 200 to about 1000 mPa*s at 25° C. at a shear rate of 20 sec-¹. In some embodiments, the viscosity of the liquid may be in the range of from about 200 to about 500 mPa*s at 25° C. at a shear rate of 20 sec-¹.

All temperatures herein are in degrees Celsius (° C.) unless otherwise indicated. Unless otherwise specified, all measurements herein are conducted at 20° C. and under the atmospheric pressure.

In all embodiments of the present invention, all percentages are by weight of the total composition, unless specifically stated otherwise. All ratios are weight ratios, unless specifically stated otherwise. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It is understood that the test methods that are disclosed in the Test Methods Section of the present application must be used to determine the respective values of the parameters of Applicants' inventions are described and claimed herein.

### Cationic Polymer

The cationic polymer used in the present invention is a terpolymer that contains three different types of structural units. It is substantially free of, and preferably essentially free of, any other structural components. The structural units, or monomers, can be incorporated in the cationic polymer in a random format or can be in a blocky format.

The first structural unit in the cationic polymer of the present invention is a nonionic structural unit derived from (meth)acrylamide (AAm). The cationic polymer contains from about 35 mol % to about 85 mol %, preferably from about 55 mol % to about 85 mol %, and more preferably from about 65 mol % to about 80 mol %, of the AAm-derived structural unit.

The second structural unit in the cationic polymer is a cationic structural unit derived from any suitable water-soluble cationic ethylenically unsaturated monomer, such as, for example, N,N-dialkylaminoalkyl methacrylate, N,N-dialkylaminoalkyl acrylate, N,N-dialkylaminoalkyl acrylamide, N,N-dialkylaminoalkylmethacrylamide, methacylamidoalkyl trialkylammonium salts, acrylamidoalkylltrialkylamminium salts, vinylamine, vinyl imidazole, quaternized vinyl imidazole and diallyl dialkyl ammonium salts.

For example, the second, cationic structural unit may be derived from a monomer selected from the group consisting of diallyl dimethyl ammonium salts (DADMAS), N,N-dimethyl aminoethyl acrylate, N,N-dimethyl aminoethyl methacrylate (DMAM), [2-(methacryloylamino)ethyl]tri-methylammonium salts, N,N-dimethylaminopropyl acrylamide (DMAPA), N,N-dimethylaminopropyl methacrylamide (DMAPMA), acrylamidopropyl trimethyl ammonium salts (APTAS), methacrylamidopropyl trimethylammonium salts (MAPTAS), and quaternized vinylimidazole (QVi), and combinations thereof.

More preferably, the second, cationic structural unit is derived from a diallyl dimethyl ammonium salt (DADMAS), such as, for example, diallyl dimethyl ammonium chloride (DADMAC), diallyl dimethyl ammonium fluoride, diallyl dimethyl ammonium bromide, diallyl dimethyl ammonium iodine, diallyl dimethyl ammonium bisulfate, diallyl dimethyl ammonium alkyl sulfate, diallyl dimethyl ammonium dihydrogen phosphate, diallyl dimethyl ammonium hydrogen alkyl phosphate, diallyl dimethyl ammonium dialkyl phosphate, and combinations thereof. Alternatively, the second, cationic structural unit can be derived from a [2-(methacryloylamino)ethyl]tri-methylammonium salt, such as, for example, [2-(methacryloylamino)ethyl]tri-methylammonium chloride, [2-(methacryloylamino)ethyl]tri-methylammonium fluoride, [2-(methacryloylamino)ethyl]tri-methylammonium bromide, [2-(methacryloylamino)ethyl]tri-methylammonium iodine, [2-(methacryloylamino)ethyl]tri-methylammonium bisulfate, [2-(methacryloylamino)ethyl]tri-methylammonium alkyl sulfate, [2-(methacryloylamino)ethyl]tri-methylammonium dihydrogen phosphate, [2-(methacryloylamino)ethyl]tri-methylammonium hydrogen alkyl phosphate, [2-(methacryloylamino)ethyl]tri-methylammonium dialkyl phosphate, and combinations thereof. Further, the second, cationic structural unit can be derived from APTAS, which include, for example, acrylamidopropyl trimethyl ammonium chloride (APTAC), acrylamidopropyl trimethyl ammonium fluoride, acrylamidopropyl trimethyl ammonium bromide, acrylamidopropyl trimethyl ammonium iodine, acrylamidopropyl trimethyl ammonium bisulfate, acrylamidopropyl trimethyl ammonium alkyl sulfate, acrylamidopropyl trimethyl ammonium dihydrogen phosphate, acrylamidopropyl trimethyl ammonium hydrogen alkyl phosphate, acrylamidopropyl trimethyl ammonium dialkyl phosphate, and combinations thereof. Still further, the second, cationic structural unit can be derived from a MAPTAS, which includes, for example, methacrylamidopropyl trimethylammonium chloride (MAPTAC), methacrylamidopropyl trimethylammonium fluoride, methacrylamidopropyl trimethylammonium bromide, methacrylamidopropyl trimethylammonium iodine, methacrylamidopropyl trimethylammonium bisulfate, methacrylamidopropyl trimethylammonium alkyl sulfate, methacrylamidopropyl trimethylammonium dihydrogen phosphate, methacrylamidopropyl trimethylammonium hydrogen alkyl phosphate, methacrylamidopropyl trimethylammonium dialkyl phosphate, and combinations thereof.

Most preferably, the second, cationic structural unit is derived from DADMAC, MAPTAC, APTAC, or QVi. Most preferably, the second cationic structural unit as mentioned herein is made directly from DADMAC. Cationic polymers containing DADMAC show better stability and lower malodor release in finish products after long shelf time, versus polymers containing other cationic monomers.

The second, cationic structural unit is present in the cationic polymer in an amount ranging from about 10 mol % to about 65 mol %, preferably from about 15 mol % to about 60 mol %, and more preferably from about 15 mol % to about 30 mol %.

Presence of the first, nonionic structural unit at a relatively large amount (e.g., 65 mol % to 80 mol %) and the second, cationic structural unit at a moderate amount (e.g., 15 mol % to 30 mol %) ensures good sudsing benefit as well as good finish product appearance. If the first, nonionic structural unit is present at less than 65 mol % and if the second, cationic structural unit is present at more than 30 mol %, the sudsing benefit or the finished product appearance starts to suffer, e.g., the rinse suds volume may increase significantly, or the finished product is no longer transparent but appears turbid. Similarly, if the first, nonionic structural unit is present at more than 85 mol % and if the second, cationic structural unit is present at less than 10 mol %, the rinse suds volume increases to a level that is no longer acceptable for the purpose of the present invention.

The third structural unit in the cationic polymer is an anionic structural unit derived from (meth)acrylic acid (AA) or anhydride thereof. The cationic polymer may contain from about 0.1 mol % to about 35 mol %, preferably from 0.2 mol % to about 20 mol %, more preferably from about 0.5 mol % to about 10 mol %, and most preferably from about 1 mol % to about 5 mol %, of the third, anionic structural unit.

Presence of the third, anionic structural unit at a relatively small amount (e.g., 1 mol % to 5 mol %) helps to increase hydrophilicity of the resulting polymer and may in turn lead to better cleaning, especially better clay removal. Too much of the third, anionic structure unit (e.g., greater than 30 mol %) may compromise the sudsing benefit of the resulting polymer.

In a specific embodiment of the present invention, the cationic polymer is a terpolymer consisting essentially of: (i) from about 55 mol % to about 85 mol % of the first, nonionic structural unit; (ii) from about 15 mol % to about 60 mol % of the second, cationic structural unit; and (iii) from about 0.2 mol % to about 20 mol %, and preferably from about 0.5 mol % to about 10 mol %, of the third, anionic structural unit. In a most preferred embodiment of the present invention, the cationic polymer is a terpolymer consisting essentially of: (i) from about 65 mol % to about 80 mol %, of the first, nonionic structural unit; (ii) from about 15 mol % to about 30 mol % of the second, cationic structural unit; and (iii) from about 1 mol % to about 5 mol %, of the third, anionic structural unit.

The molar ratio of the second, cationic structure unit (ii) to the third, anionic structural unit (iii) is preferably from about 1.5 to about 30, more preferably from about 2 to about 20, and most preferably from about 3 to about 10. This ensures that the resulting polymer carries a net cationic charge and an appropriate overall charge density, which is important for achieving the desired sudsing performance. The cationic polymer of the present invention preferably has a cationic (or positive) charge density ranging from about 0.05 to about 10 milliequivalents/g, preferably from about 0.5 to about 5 milliequivalents/g, and more preferably from about 1 to about 4 milliequivalents/g.

The specific molar percentage ranges of the first, second, and third, structural units of the cationic polymer as specified hereinabove is important for optimizing the sudsing profile generated by the laundry detergent compositions containing such cationic polymer during the wash and rinse cycles. Further, phase stability of the finished products containing the cationic polymer of the present invention can be impacted by the molar percentage ranges of respective structural units in the cationic polymer, which are also selected carefully to minimize phase separation of the finished products.

The weight average molecular weight (Mw) of the cationic polymer may range from about 1,000 to about 300,000 Daltons, preferably from about 10,000 to about 250,000 Daltons, and more preferably from about 20,000 to about 200,000 Daltons. The specific molecular weight range is effective in reducing the whiteness loss that is commonly seen in fabrics after they have been exposed to multiple washes. Cationic polymers have been known to contribute to fabric whiteness loss, which is a limiting factor for wider usage of such polymers. By controlling the molecular weight of the cationic polymer within the above-described specific range, the fabric whiteness loss can be effectively reduced in comparison with conventional cationic polymers. Further, finished product rheology can also be impacted by molecular weight of the cationic polymer. Therefore, the molecular weight of the cationic polymer of the present invention is also carefully selected to minimize adverse impact on the finished product rheology.

### Laundry Detergent Including a Cationic Polymer and Related Methods

The present invention discovers that the above-described cationic polymer, when used in a laundering detergent composition at an amount ranging from 0.01 wt % to 15 wt %, is effective in improving the sudsing profile of such laundry detergent composition, in comparison with a composition of similar formulae but without such cationic polymer.

Preferably but not necessarily, the cationic polymer is provided in the cleaning or laundry detergent composition at an amount ranging preferably from 0.05 wt % to about 10 wt %, more preferably from about 0.1 wt % to about 5 wt %, and most preferably from about 0.2 wt % to about 1 wt %. Further, it is preferred, although not necessary, that the cationic polymer is substantially free of carrier particles or coating. This is advantageous as it avoids an extra step and cost associated with the incorporation of these materials.

Laundry detergent compositions containing the cationic polymer of the present invention are characterized by an improved sudsing profile defined by: (1) a Wash Suds Index (WSI) of more than 90%, preferably more than 95%, and more preferably more than 100%; and (2) a Rinse Suds Index (RSI) of less than 50%, preferably less than 45%, and more preferably less than 40%, as determined by the Sudsing Profile Test described hereinafter. Preferably, the laundry detergent composition of the present invention has an optimal sudsing profile that is defined by a WSI of more than about 95% and a RSI of less than about 45%. More preferably, the laundry detergent composition of the present invention has an optimal sudsing profile that is defined by a WSI of more than about 100% and a RSI of less than about 40%.

The laundry detergent compositions of the present invention can be used in applications such as automatic washing machine laundering, semi-automatic machine laundering (i.e., machine washing that requires at least one or two manual steps), hand-washing, etc. Preferably, the laundry detergent composition is a designated for hand-washing laundry detergent product.

The laundry detergent compositions can be in any form, namely, in the form of a liquid; an emulsion; a paste; a gel; a spray or foam; a solid such as a powder, granules, agglomerate, tablet, pouches, and bar; types delivered in dual- or multi-compartment containers or pouches; premoistened or dry wipes (i.e., a liquid detergent composition in combination with a nonwoven material or a powder detergent composition in combination with a nonwoven material) that can be activated with water by a consumer; and other homogeneous or multiphase consumer cleaning product forms.

The laundry detergent composition of the present invention is preferably a liquid laundry detergent. The liquid laundry detergent composition has a viscosity from about 1 to about 2000 centipoise (1-2000 mPa·s), or from about 200 to about 800 centipoises (200-800 mPa·s). The viscosity can be determined using a Brookfield viscometer, No. 2 spindle, at 60 RPM/s, measured at 25° C. Liquid compositions contained in encapsulated and/or unitized dose products are included, as are compositions which comprise two or more separate but jointly dispensable portions. More preferably, the liquid laundry detergent composition is designated for hand-washing, where the improved suds benefit or superior sudsing profile is most evident to the consumer. The liquid laundry detergent composition preferably contains water as an aqueous carrier, and it can contain either water alone or mixtures of organic solvent(s) with water as carrier(s). Suitable organic solvents are linear or branched lower C₁-C₈ alcohols, diols, glycerols or glycols; lower amine solvents such as C₁-C₄ alkanolamines, and mixtures thereof. Exemplary organic solvents include 1,2-propanediol, ethanol, glycerol, monoethanolamine and triethanolamine. The carriers are typically present in a liquid composition at levels in the range of from about 0.1% to about 98%, preferably from about 10% to about 95%, more preferably from about 25% to about 75% by total weight of the liquid composition. In some embodiments, water is from about 85 to about 100 wt % of the carrier. In other embodiments, water is absent and the composition is anhydrous. Highly preferred compositions afforded by the present invention are clear, isotropic liquids.

The laundry detergent composition of the present invention is preferably a base formulation, i.e., it is characterized by a pH (measured neat) of equal to or greater than about 7. The neat pH of a detergent composition is provided by trim addition of an alkaline neutralizer, such as sodium hydroxide or sodium hydroxide solution to the composition at a sufficient level to obtain the desired neat pH.

Laundry detergent compositions of the present invention may comprise one or more surfactants at amounts ranging from about 1% to about 80%, more preferably from about 1% to about 50%, and more preferably from about 5% to about 30% by total weight of the compositions. Detersive surfactants utilized can be of the anionic, nonionic, zwitterionic, amphoteric or cationic type or can comprise compatible mixtures of these types.

Anionic surfactants are preferred. Useful anionic surfactants can themselves be of several different types. For example, non-soap synthetic anionic surfactants are particularly suitable for use herein, which include the water-soluble salts, preferably the alkali metal, and ammonium salts, of organic sulfuric reaction products having in their molecular structure an alkyl group (included in the term “alkyl” is the alkyl portion of acyl groups) containing from about 10 to about 20 carbon atoms and a sulfonic acid or sulfuric acid ester group. Examples of this group of synthetic anionic surfactants include, but are not limited to: a) the sodium, potassium and ammonium alkyl sulfates with either linear or branched carbon chains, especially those obtained by sulfating the higher alcohols (C₁₀-C₂₀ carbon atoms), such as those produced by reducing the glycerides of tallow or coconut oil; b) the sodium, potassium and ammonium alkylalkoxy sulfates with either linear or branched carbon chains, particularly those in which the alkyl group contains from about 10 to about 20, preferably from about 12 to about 18 carbon atoms, and wherein the alkoxylated chain has, in average, a degree of ethoxylation ranging from about 0.1 to about 5, preferably from about 0.3 to about 4, and more preferably from about 0.5 to about 3; c) the sodium and potassium alkyl benzene sulfonates in which the alkyl group contains from about 10 to about 20 carbon atoms in either a linear or a branched carbon chain configuration, preferably a linear carbon chain configuration; d) the sodium, potassium and ammonium alkyl sulphonates in which the alkyl group contains from about 10 to about 20 carbon atoms in either a linear or a branched configuration; e) the sodium, potassium and ammonium alkyl phosphates or phosphonates in which the alkyl group contains from about 10 to about 20 carbon atoms in either a linear or a branched configuration, f) the sodium, potassium and ammonium alkyl carboxylates in which the alkyl group contains from about 10 to about 20 carbon atoms in either a linear or a branched configuration, and combinations thereof; g) the sodium, potassium and ammonium alkyl ester sulfonates, for example of formula R—CH(SO₃M)-CH₂COOR′, or the sodium, potassium and ammonium alkyl ester sulfates, for example of formula R—CH(OSO₃M)-CH₂COOR′, where R represents a C₁₀-C₂₀ and preferably C₁₀-C₁₆ linear or branched alkyl radical, R′ represents a C₁-C₆ and preferably C₁-C₃ alkyl radical, and M represents a sodium, potassium or the ammonium cation.

Especially preferred for the practice of the present invention are anionic surfactant systems containing C₁₀-C₂₀ linear alkyl benzene sulphonates, C₁₀-C₂₀ linear or branched alkylalkoxy sulfates having a weight average degree of alkoxylation ranging from about 0.1 to about 5 (preferably from about 0.3 to about 4 and more preferably from about 0.5 to about 3, which is particularly advantageous for improving the sudsing profile of the detergent composition), or mixtures thereof. More preferably, the surfactant system of the present invention is enriched with C₁₀-C₂₀ linear or branched alkylalkoxy sulfates (AES), i.e., the AES surfactant(s) are present in an amount that is equal to or greater than any other detersive surfactant contained by the surfactant system, such as the C₁₀-C₂₀ linear alkyl benzene sulphonates or the nonionic surfactants. Still more preferably, the surfactant system of the present invention is composed of 50% or more, and most preferably 60% or more, by total weight of said surfactant system, of AES surfactant(s), which preferably but not necessarily have a weight average degree of alkoxylation ranging from about 0.5 to about 3. Without being bound by any theory, it is believed that an alkylalkoxy sulfate-enriched surfactant system can help to further improve the sudsing benefit of the cationic polymer of the present invention.

The anionic surfactants can be provided in the laundry detergent compositions of the present invention at levels ranging from about 1 wt % to about 50 wt %, more preferably from about 2 wt % to about 40 wt %, and more preferably from about 5 wt % to about 30 wt % by total weight of the compositions. In one particularly preferred embodiment, the laundry detergent composition of the present invention is a liquid laundry detergent composition containing from about 1 wt % to about 50 wt % of one or more anionic surfactants selected from the group consisting of C₁₀-C₂₀ linear alkyl benzene sulphonates, C₁₀-C₂₀ linear or branched alkylalkoxy sulfates having a weight average degree of alkoxylation ranging from 0.1 to 5.0, C₁₀-C₂₀ linear or branched alkyl sulfates, C₁₀-C₂₀ linear or branched alkyl ester sulfates, C₁₀-C₂₀ linear or branched alkyl sulphonates, C₁₀-C₂₀ linear or branched alkyl ester sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof. More preferably, said one or more anionic surfactants are selected from the group consisting of C₁₀-C₂₀ linear alkyl benzene sulphonates, C₁₀-C₂₀ linear or branched alkylalkoxy sulfates having weight average degree of alkoxylation ranging from about 0.5 to about 3, methyl ester sulfonates with a C₁₀-C₂₀ linear or branched alkyl group, and combinations thereof, and are present in an amount ranging from about 5 wt % to about 30 wt % of the liquid laundry detergent composition.

Water-soluble salts of the higher fatty acids, i.e., “soaps”, are also useful anionic surfactants in the laundry detergent compositions of the present invention. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. For example, the laundry detergent composition can be a liquid composition containing from about 0.1 wt % to about 5 wt %, preferably from about 0.5 wt % to about 4 wt %, more preferably from about 1 wt % to about 3 wt %, of one or more fatty acids and/or alkali salts thereof. Exemplary fatty acids or salts thereof that can be used may be selected from caprylic acid, capric acid, lauric acid, myristic acid, myristoleic acid, palmitic acid, palmitoleic acid, sapienic acid, stearic acid, oleic acid, elaidic acid, vaccenic acid, linoleic acid, linoelaidic acid, α-linoelaidic acid, arachidic acid, arachidonic acid, eicosapentaenoic acid, behenic acid, erucic acid, and docosahexaenoic acid, and salts thereof. Further, it is preferred that the liquid laundry detergent composition of the present invention comprises one or more saturated fatty acids or salts thereof, such as caprylic acid, capric acid, lauric acid, myristic acid, palmitic acid, stearic acid, arachidic acid, behenic acid, and salts thereof. Among the above-listed saturated fatty acids, lauric acid, myristic acid, palmitic acid and salts thereof are particularly preferred. However, in certain preferred embodiments of the present invention, the laundry detergent compositions contain fatty acids or salts at a relatively low level, e.g., preferably no more than about 3 wt %, more preferably no more than about 2 wt %, and most preferably no more than about 1 wt %, said laundry detergent composition is essentially free of fatty acids or salts thereof.

Nonionic surfactants can also be included into the surfactant systems of the present invention, which include those of the formula R¹(OC₂H₄)ₙ OH, wherein R¹ is a C₈-C₁₈ alkyl group or alkyl phenyl group, and n is from about 1 to about 80. Particularly preferred are C₈-C₁₈ alkyl alkoxylated alcohols having an average degree of alkoxylation from about 1 to about 20. The nonionic surfactants can be provided in the laundry detergent compositions at levels ranging from about 0.05 wt % to about 20 wt %, preferably from about 0.1 wt % to about 10 wt %, and most preferably from about 1 wt % to about 5 wt %. However, in certain preferred embodiments of the present invention, the laundry detergent compositions contains nonionic surfactants at a relatively low level, e.g., no more than about 3 wt %, more preferably not more than about 2 wt % or 1 wt %, and most preferably said laundry detergent composition is essentially free of nonionic surfactants.

Other surfactants useful herein include amphoteric surfactants, zwitterionic surfactants and cationic surfactants. Such surfactants are well known for use in laundry detergents and are typically present at levels from about 0.2 wt %, 0.5 wt % or 1 wt % to about 10 wt %, 20 wt % or 30 wt %.

In a preferred but not necessary embodiment of the present invention, the laundry detergent composition contains from about 0.5 wt % to about 20 wt % of one or more amphoteric and/or zwitterionic surfactants. Preferred amphoteric surfactants are selected from the group consisting of amine oxide surfactants, such as, for example, alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides are characterized by a formula R₁—N(R₂)(R₃)—O, wherein R₁ is a C₈₋₁₈ alkyl, and wherein R₂ and R₃ are independently selected from the group consisting of C₁₋₃ alkyls and C₁₋₃ hydroxyalkyls, such as methyl, ethyl, propyl, isopropyl, 2-hydroxethyl, 2-hydroxypropyl and 3-hydroxypropyl. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from about 10 to about 24 carbon atoms, preferably from about 12 to about 20, and more preferably from about 10 to about 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least about 50 wt %, more preferably at least about 75 wt % to about 100 wt %, of the mid-branched amine oxides for use herein. Particularly preferred amphoteric surfactants are C₁₀-C₁₄ alkyl dimethyl amine oxides. Preferred zwitterionic surfactants are betaine surfactants, such as, for example, alkyl betaines, alkylamidobetaines, amidazoliniumbetaines, sulfobetaines (also referred to as sultaines) as well as phosphobetaines. A particularly preferred betaine is cocoamidopropylbetaine.

In one particularly preferred embodiment, the liquid laundry detergent composition of the present invention contains: (1) from about 0.2 wt % to about 1 wt % of the cationic polymer, which has a molecular weight of from about 30,000 to about 200,000 Daltons and consists essentially of from 65 mol % to 80 mol % of the first, nonionic structural unit derived from (meth)acrylamide (AAm), from 15 mol % to 30 mol % of the second, cationic structural unit derived from diallyl dimethyl ammonium chloride (DADMAC), from 1 mol % to 5 mol % of the third, anionic structural unit derived from (meth)acrylic acid (AA) or anhydride thereof; and (2) from about 5 wt % to about 30 wt % of one or more anionic surfactants selected from the group consisting of C₁₀-C₂₀ linear alkyl benzene sulphonates, C₁₀-C₂₀ linear or branched alkylalkoxy sulfates having a weight average degree of alkoxylation ranging from about 0.5 to about 3, methyl ester sulfonates with a C₁₀-C₂₀ linear or branched alkyl group, and combinations thereof.

### Additional Laundry Detergent Ingredients

The balance of the laundry detergent typically contains from about 5 wt % to about 70 wt %, or about 10 wt % to about 60 wt % adjunct ingredients.

Suitable adjunct ingredients for laundry detergent products include: builders, chelating agents, dye transfer inhibiting agents, dispersants, rheology modifiers, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, free perfume oils, and/or pigments. Suitable adjunct ingredients and levels of use are well known in the art. The precise nature of these adjunct ingredients and the levels thereof in the laundry detergent composition will depend on factors like the specific type of the composition and the nature of the laundering process for which it is to be used.

If the laundry detergent composition of the present invention is provided in a powder form, it may also be especially preferred for the powder to comprise low levels, or even be essentially free, of builder. The term “essentially free” means that the composition “comprises no deliberately added” amount of that ingredient. In a preferred embodiment, the laundry detergent composition of the present invention comprises no builder.

When the laundry detergent composition of the present invention is a liquid detergent product, it may contain an external structurant, which may be present in an amount ranging from about 0.001% to about 1.0%, preferably from about 0.05% to about 0.5%, more preferably from about 0.1% to about 0.3% by total weight of the composition. Suitable external structurants include: (i) non-polymeric, crystalline, hydroxyl-containing materials which can form thread-like structuring systems throughout a liquid matrix when they are crystallized within the matrix in situ. Such materials can be generally characterized as crystalline, hydroxyl-containing fatty acids, fatty esters or fatty waxes; and (ii) polymeric structurants such as polyacrylates and derivatives thereof; copolymers of acrylate and methacrylate. A particularly preferred external structurant for the practice of the present invention is hydrogenated castor oil, which is also referred to as trihydroxylstearin and is commercially available under the tradename Thixin®.

Such liquid laundry detergent composition may further contain from about 0.2 wt % to about 1 wt % of the silicone-derived antifoaming agent.

In a specific embodiment of the present invention, a silicone-derived anti-foaming agent is used in combination with the cationic polymer. Although not necessary for carrying out the present invention, such silicone-derived anti-foaming agent may further improve the sudsing profile of the laundry detergent composition.

The silicone-derived anti-foaming agent can be any suitable organosilicones, including, but not limited to: (a) non-functionalized silicones such as polydimethylsiloxane (PDMS); and (b) functionalized silicones such as silicones with one or more functional groups selected from the group consisting of amino, amido, alkoxy, alkyl, phenyl, polyether, acrylate, siliconehydride, mercaptoproyl, carboxylate, sulfate phosphate, quaternized nitrogen, and combinations thereof. In typical embodiments, the organosilicones suitable for use herein have a viscosity ranging from about 10 to about 700,000 CSt (centistokes) at 20° C. In other embodiments, the suitable organosilicones have a viscosity from about 10 to about 100,000 CSt.

Polydimethylsiloxanes (PDMS) can be linear, branched, cyclic, grafted or cross-linked or cyclic structures. In some embodiments, the detergent compositions comprise PDMS having a viscosity of from about 100 to about 700,000 CSt at 20° C. Exemplary functionalized silicones include but are not limited to aminosilicones, amidosilicones, silicone polyethers, alkylsilicones, phenyl silicones and quaternary silicones. A preferred class of functionalized silicones comprises cationic silicones produced by reacting a diamine with an epoxide. One embodiment of the composition of the present invention contains organosilicone emulsions, which comprise organosilicones dispersed in a suitable carrier (typically water) in the presence of an emulsifier (typically an anionic surfactant). In another embodiment, the organosilicones are in the form of microemulsions having an average particle size in the range from about 1 nm to about 150 nm, or from about 10 nm to about 100 nm, or from about 20 nm to about 50 nm.

The silicone-derived anti-foaming agent as mentioned hereinabove can be present in the laundry detergent composition in an amount ranging from about 0.01% to about 5%, preferably from about 0.1% to about 2%, and more preferably from about 0.2% to about 1%, by total weight of the composition.

It may also be especially preferred for the laundry detergent powder to comprise low levels, or even be essentially free, of builder. The term “essentially free” means that the composition “comprises no deliberately added” amount of that ingredient. In a preferred embodiment, the laundry detergent composition of the present invention comprises no builder.

### Method of Making the Laundry Detergent Composition

Incorporation of the cationic polymer and various other ingredients as described hereinabove into laundry detergent compositions of the invention can be done in any suitable manner and can, in general, involve any order of mixing or addition.

For example, the cationic polymer as received from the manufacturer can be introduced directly into a preformed mixture of two or more of the other components of the final composition. This can be done at any point in the process of preparing the final composition, including at the very end of the formulating process. That is, the cationic polymer can be added to a pre-made liquid laundry detergent to form the final composition of the present invention.

In another example, the cationic polymer can be premixed with the surfactants, or an emulsifier, or a dispersing agent, or a suspension agent to form an emulsion, a latex, a dispersion, a suspension, and the like, which is then mixed with other components of the final composition. These components can be added in any order and at any point in the process of preparing the final composition.

A third example involves mixing the cationic polymer with one or more adjuncts of the final composition and adding this premix to a mixture of the remaining adjuncts.

### Methods of Using the Laundry Detergent Composition

The present invention is directed to a method of cleaning fabric, the method comprising the steps of: (i) providing a laundry detergent as described above; (ii) forming a laundry liquor by diluting an effective amount of the laundry detergent with water; (iii) washing fabric in the laundry liquor; and (iv) rinsing the fabric in water, wherein after 2 or less rinses, preferably after 1 rinse, the laundry liquor is substantially free of suds, or at least 75%, preferably at least 85%, more preferably 95%, and even more preferably at least 99% of a surface area of the laundry liquor is free from suds.

The present invention is also directed to a method of saving water during laundering, the method comprising the steps of: (i) providing a laundry detergent composition as described above; (ii) diluting an effective amount of the laundry detergent composition with wash water in a container to form a laundry liquor; (iii) washing laundry in the laundry liquor; and (iv) rinsing the laundry, wherein after 2 or less rinses, preferably after 1 rinse, the laundry liquor is substantially free of suds.

An “effective amount” of the laundry detergent composition means from about 20 g to about 300 g of product dissolved or dispersed in a wash solution of volume from about 5 L to about 65 L. The water temperatures may range from about 5° C. to about 100° C. The volume-based dilution factor may range from 20 to 5000, preferably from 100 to 1500, and more preferably from 500 to 1000. The water to fabric ratio may be from about 1:1 to about 30:1. The laundry detergent compositions may be dosed in such amounts to reach in-wash (i.e., in the wash solution) concentrations from about 500 ppm to about 15,000 ppm, preferably from about 1,000 ppm to about 10,000 ppm, more preferably from about 2,000 ppm to about 5,000 ppm, and most preferably from about 3,000 ppm to about 4,000 ppm. In the context of a fabric laundry composition, usage levels may also vary depending not only on the type and severity of the soils and stains, but also on the wash water temperature, the volume of wash water, and the type of washing machine (e.g., top-loading, front-loading, top-loading, vertical-axis Japanese-type automatic washing machine).

The method of laundering fabric may be carried out in a top-loading or front-loading automatic washing machine, or can be used in a hand-wash laundry application, which is particularly preferred in the present invention.

### Test Methods

Various techniques are known in the art to determine the properties of the compositions of the present invention comprising the cationic polymer. However, the following assays must be used in order that the invention described and claimed herein may be fully understood.

### Test 1: Measurement of Weight Average Molecular Weight (Mw)

The weight-average molecular weight (Mw) of a polymer material of the present invention is determined by Size Exclusion Chromatography (SEC) with differential refractive index detection (RI). One suitable instrument is Agilent® GPC-MDS System using Agilent® GPC/SEC software, Version 1.2 (Agilent, Santa Clara, USA). SEC separation is carried out using three hydrophilic hydroxylation polymethyl methacrylate gel columns (Ultrahydrogel 2000-250-120 manufactured by Waters, Milford, USA) directly joined to each other in a linear series and a solution of 0.1M sodium chloride and 0.3% trifluoroacetic acid in DI-water, which is filtered through 0.22 μm pore size GVWP membrane filter (MILLIPORE, Mass., USA). The RI detector needs to be kept at a constant temperature of about 5-10° C. above the ambient temperature to avoid baseline drift. It is set to 35° C. The injection volume for the SEC is 100 μL. Flow rate is set to 0.8 ml/min. Calculations and calibrations for the test polymer measurements are conducted against a set of 10 narrowly distributed Poly(2-vinylpyridin) standards from Polymer Standard Service (PSS, Mainz Germany) with peak molecular weights of: Mp=1110 g/mol; Mp=3140 g/mol; Mp=4810 g/mol; Mp=11.5 k g/mol; Mp=22 k g/mol; Mp=42.8 k g/mol; Mp=118 k g/mol; Mp=256 k g/mol; Mp=446 k g/mol; and Mp=1060 k g/mol.

Each test sample is prepared by dissolving the concentrated polymer solution into the above-described solution of 0.1M sodium chloride and 0.3% trifluoroacetic acid in DI water, to yield a test sample having a polymer concentration of 1 to 2 mg/mL. The sample solution is allowed to stand for 12 hours to fully dissolve, and then stirred well and filtered through a 0.45 μm pore size nylon membrane (manufactured by WHATMAN, UK) into an auto sampler vial using a 5 mL syringe. Samples of the polymer standards are prepared in a similar manner. Two sample solutions are prepared for each test polymer. Each solution is measured once. The two measurement results are averaged to calculate the Mw of the test polymer.

For each measurement, the solution of 0.1M sodium chloride and 0.3% trifluoroacetic acid in DI water is first injected onto the column as the background. A correction sample (a solution of 1 mg/mL polyethylene oxide with Mp=111.3 k g/mol) is analysed six times prior to other sample measurements, so as to verify repeatability and accuracy of the system.

The weight-average molecular weight (Mw) of the test sample polymer is calculated using the software that accompanies the instrument and selecting the menu options appropriate for narrow standard calibration modelling. A third-order polynomial curve is used to fit the calibration curve to the data points measured from the Poly(2-vinylpyridin) standards. The data regions used for calculating the weight-average molecular weight are selected based upon the strength of the signals detected by the RI detector. Data regions where the RI signals are greater than 3 times the respective baseline noise levels are selected and included in the Mw calculations. All other data regions are discarded and excluded from the Mw calculations. For those regions which fall outside of the calibration range, the calibration curve is extrapolated for the Mw calculation.

To measure the average molecular weight of a test sample containing a mixture of polymers of different molecular weights, the selected data region is cut into a number of equally spaced slices. The height or Y-value of each slice from the selected region represents the abundance (Ni) of a specific polymer (i), and the X-value of each slice from the selected region represents the molecular weight (Mi) of the specific polymer (i). The weight average molecular weight (Mw) of the test sample is then calculated based on the equation described hereinabove, i.e., Mw=(Σi Ni Mi2)/(Σi Ni Mi).

### Test 2: Qualification of the Monomers by HPLC

Each of the monomers in the cationic polymer is quantified by high pressure liquid chromatography (HPLC) according to the follows:

| | |
|---|---|
| Measuring device: | L-7000 series (Hitachi Ltd.) |
| Detector: | UV detector, L-7400 (Hitachi Ltd.) |
| Column: | SHODEX RSpak DE-413 (product of Showa |
| | Denko K.K.) |
| Temperature: | 40° C. |
| Eluent: | 0.1% phosphoric acid aqueous solution |
| Flow Velocity: | 1.0 mL/min |

### Test 3: Performance Evaluation (Sudsing Profile Test)

The sudsing profile of the detergent composition herein is measured by employing a suds cylinder tester (SCT). The SCT has a set of 8 cylinders. Each cylinder is typically 60 cm long and 9 cm in diameter and may be together rotated at a rate of 20-22 revolutions per minute (rpm). This method is used to assay the performance of laundry detergent to obtain a reading on ability to generate suds as well as its suds stability and rinse suds performance. The following factors affect results and therefore should be controlled properly: (a) concentration of detergent in solution, (b) water hardness, (c) water temperature of water, (d) speed and number of revolutions, (e) soil load in the solution, and (f) cleanliness of the inner part of the tubes.

The performance is determined by comparing the suds height generated during the washing stage by the laundry detergent containing the cationic polymer of the present invention or a comparative cationic polymer not falling within the scope of the present invention, versus control laundry detergent that does not contain any cationic polymer. The height of suds generated by each test composition is measured by recording the total suds height (i.e., height of suds plus wash liquor) minus the height of the wash liquor alone.
1. Weigh 1.5 grams of product and dissolve it in 300 ml of water with a water hardness of about 16 gpg for at least 15 min to form a solution containing the test product at about 5000 ppm. Dissolve the samples simultaneously.
2. Pour the sample aliquot to the tubes. Put in the rubber stopper and lock the tubes in place.
3. Spin for 10 revolutions. Lock in an upright position. Wait 1 min and check the suds height very quickly (˜10 sec) left to right. Record the total suds height (i.e., height of the suds plus wash liquor) and the height of the wash liquor alone. This marks the after 10 revolutions data.
4. Spin for additional 20 revolutions. This marks the after 30 revolutions data. Take recordings from left to right.
5. Spin for 20 revolutions more. This marks the after 50 revolutions data. Take readings from left to right. Repeat this step one more time; thus, the data gathered are for after 70 revolutions.
6. Open the tubes. Add 1 piece of fabric with clay and ¼ piece of fabric with dirty cooking oil (DCO) into each tube. Put in the rubber stopper. Spin for 20 revolutions. This marks the after 90 revolutions data. Take readings. Repeat this step one time; thus, the data gathered are for after 110 revolutions.
   The addition of the artificial soil is intended to mimic the real world washing conditions where more soils dissolve into the wash liquor from the fabrics being wash. Therefore, this test is relevant for determing the initial sudsing profile of a composition and its sudsing profile in a washing cycle.
   (Note: Preparation of fabric with clay is conduted as follows:
      Disperse 20 g of BJ-clay (clay collected from 15 cm below the earth surface in Beijing, China) into 80 ml of DI water via agitation to make a clay suspension.
      Keep agitating the suspension during the preparation process, while brushing 2 g of such clay suspension onto the center of a 10 cm*10 cm cotton fabric to form a round shape stain (d=5 cm).
      The cotton fabric with clay is left dry at room temperature and then used for the performance evaluation.
   Preparation of fabric with DCO is conducted as follows:
      100 grams of peanut oil is used to fry 20 grams of salty fish for 2 hrs at 150-180° C. to form the dirty cooking oil (DCO).
      Brush 0.6 ml of the DCO onto the center of a 10 cm*10 cm cotton fabric to form a round shape stain (d=5 cm).
      Cut the 10 cm*10 cm cotton fabric into 4 equal pieces and use one for the performance evaluation.)
7. Pour 37.5 ml solution out of the tube gently into beaker and add 262.5 ml of water with desired hardness level into the beaker to make a total of 300 ml ⅛ diluted solution. Dispose the remaining solution in the tube and wash the tube with tap water. Pour the 300 ml ⅛ diluted solution into the same tube.
8. Spin for 20 revolutions. This marks the after 130 revolutions data. Take readings from left to right. Repeat this step one time; thus data gathered are for after 150 revolutions.
9. Pour 150 ml solution out of the tube gently into beaker and add 150 ml water with desired hardness level into the beaker to make a total of 300 ml 1/16 diluted solution. Dispose the remaining solution in the tube and wash the tube with tap water. Pour the 300 mL 1/16 diluted solution into the same tube. Repeat steps 8. Data gathered are for 190 revolutions data.
10. In a typical sudsing profile test, Steps 1-9 are repeated at least once to ensure the test repeatibility.
11. Data Analysis: Breakdown of the Suds Category

| | | |
|---|---|---|
| Flush Suds | 10 revolutions data | Flush Suds |
| Suds generation | 30-70 revolutions data | Washing Cycle |
| Suds stability | 90-110 revolutions data | Wash data analysis is |
| | | focused on Suds stability |
| ⅛ Rinse | 130-150 revolutions data | Rinsing Cycle: Rinse data |
| | | analysis is focused on Rinse |
| | | (1:8) |
| 1/16 Rinse | 170-190 revolutions data | Rinsing Cycle: 1/16 Rinse |

Average suds height of different categories described above are calculated by average the height data of each replicate.

Washing Suds Index (WSI) is calculated by the average suds height generated by the control sample (WSH_{C}) during the wash cycle when suds stability is observed (i.e., 90-110 revolutions) divided by that generated by a test sample (WSH_{T}), i.e., containing a cationic polymer of the present invention, and then converted into a percentage, as follows:

Washing Suds Index=WSH_{T}/WSH_{C}×100%.

The WSI is indicative of how much suds is generated during the wash cycle by a test sample containing a cationic polymer, in comparison with the suds generated by a control sample that does not contain any of such cationic polymer. Therefore, the higher the WSI percentage, the more suds are generated during wash, and the better the performance.

Rinse Suds Index (RSI) is calculated by the average suds height generated by the control sample (RSH_{C}) during the ⅛ rinse cycle (i.e., 130-150 revolutions) divided by that generated by a test sample (RSH_{T}), and then converted into a percentage, as follows:

Rinse Suds Index=RSH_{T}/RSH_{C}×100%.

The RSI, on the other hand, is indicative of how much suds is left during the rinse cycle by a test sample containing a cationic polymer, in comparison with the suds left by a control sample that does not contain any of such cationic polymer. Therefore, the lower the RSI percentage, the more suds reduction is effectuated during rinse, and the better the performance.

An optimal sudsing profile as defined within the meaning of this invention includes a WSI of more than 90% and a RSI of less than 50%, preferably a WSI of more than 95% and a RSI of less than 45%, and more preferably a WSI of more than 100% (i.e., a suds boosting effect during wash) and a RSI of less than 40%.

### Examples

### I. Cationic Polymer Examples

Following is a list of exemplary cationic polymers either falling within the scope of the present invention (i.e., inventive examples) or outside of the scope of the present invention (i.e., comparative examples.

TABLE I

| | | | | MW | | Calculated |
|---|---|---|---|---|---|---|
| | AAm | DADMAC | AA | (K | DADMAC:AA | Charge Density |
| Polymers | (mol %) | (mol %) | (mol %) | Dalton) | Molar Ratio | (meq/g) |
| Inventive | 40 | 56 | 4 | 63 | 14 | 4.27 |
| Polymer 1 | | | | | | |
| Inventive | 55 | 41 | 4 | 82 | 10.25 | 3.42 |
| Polymer 2 | | | | | | |
| Inventive | 70 | 26 | 4 | 36 | 6.5 | 2.32 |
| Polymer 3 | | | | | | |
| Inventive | 80 | 16 | 4 | 123 | 4 | 1.40 |
| Polymer 4 | | | | | | |
| Inventive | 80 | 16 | 4 | 192 | 4 | 1.40 |
| Polymer 5 | | | | | | |
| Comparative | 90 | 6 | 4 | 285 | 1.5 | 0.26 |
| Polymer A | | | | | | |
| Comparative | 35 | 30 | 35 | 1747 | 0.86 | −0.51 |
| Polymer B | | | | | | |
| Comparative | 40 | 29 | 31 | 62 | 0.94 | −0.20 |
| Polymer C | | | | | | |

II. Comparative Tests Showing Sudsing Profiles and Phase Stability of Inventive and Comparative Cationic Polymers with Different AAm/DADMAC/AA Molar Percentages

Nine (9) test liquid laundry detergent compositions are prepared, including: (1) a control composition containing no cationic polymer, (2) 5 inventive compositions, each of which containing the same ingredients as the control composition but further including 0.5 wt % of an inventive polymer (Inventive Polymers 1-5 from Example I hereinabove) within the scope of the present invention; and (3) 3 comparative compositions, each of which containing the same ingredients as the control composition but further including 0.5 wt % of a comparative polymer (Comparative Polymers A-C from Example I hereinabove) falling outside of the scope of the present invention. Following is the detailed compositional breakdown of the control composition:

TABLE II

| Ingredients | Wt % |
|---|---|
| C24AE3S Paste | 8.320 |
| HLAS | 5.520 |
| Nonionic 24-7 | 1.210 |
| Citric Acid | 2.000 |
| Fatty acid (DTPK) | 1.210 |
| Subtotal Builder | 3.210 |
| Boric acid | 2.100 |
| DTPA | 0.190 |
| FWA-49 | 0.057 |
| Hexamethylene diamine (ethoxylated, | 0.460 |
| quaternized, sulfated) 70% | |
| 1,2 propanediol | 1.210 |
| NaOH | 3.130 |
| Acticide MBS | 0.015 |
| Proxel GXL | 0.001 |
| Silicone emulsion | 0.003 |
| Andromeda | 0.600 |
| Liquitint Blue 297 | 0.002 |
| Water | Balance |
| Total | 100.000 |

Sudsing Profile Test as described hereinabove is carried out for each of these nine (9) test compositions by dissolving each composition in water having a water hardness level of 16 gpg to form a laundering liquor containing 5000 ppm of the test composition. The suds test was repeated twice and the average data was reported. The Wash Suds Index (WSI) and Rinse Suds Index (RSI) of each of the three (3) comparative compositions and five (5) inventive compositions are calculated based on the wash suds volume and rinse suds volume measured for such compositions in comparison with the control composition. Following are the measurement results:

TABLE III

| Polymer in Composition | WSI (%) | RSI (%) | Phase Stability*** |
|---|---|---|---|
| No polymer (Control) | 100% | 100% | Transparent |
| Inventive Polymer 1 | 96% | 47% | Turbid |
| Inventive Polymer 2 | 96% | 42% | Slightly Turbid |
| Inventive Polymer 3 | 102% | 31% | Transparent |
| Inventive Polymer 4 | 107% | 39% | Transparent |
| Inventive Polymer 5 | 95% | 40% | Transparent |
| Comparative Polymer A | 110% | 104% | Transparent |
| Comparative Polymer B | 115% | 97% | Transparent |
| Comparative Polymer C | 105% | 58% | Transparent |

* Suds stability measured at 90-110 revolutions.
** First rinse suds measured at 130-150 revolutions.
***Phase Stability is determined herein visually by placing the composition in a transparent glass tube of about 2.5 cm in diameter for about 24 hours after the composition is made. A visually transparent product is considered phase stable, while a visually turbid product is considered unstable and phase separated, although there may be different degree of phase separation.

The above data shows that all of the inventive polymers provide optimal sudsing profiles, i.e., a WSI of more than 90% and a RSI of less than 50%, while all of the comparative polymers fail to provide such optimal sudsing profile due to high RSI. Among the inventive polymers, Inventive Examples 3-5 are more preferred, due to better sudsing profile as well as better phase stability. Inventive Examples 1-2, although having the optimal sudsing profile, exhibit some degree of phase separation, due to relatively low AAm molar percentage and relatively high DADMAC molar percentage, and are therefore less preferred.

### III. Exemplary Laundry Detergent Compositions

### (A). Heavy Duty Powder Detergents

The following heaving duty powder detergents are prepared by mixing the ingredients listed below via conventional processes. Such heavy duty liquid detergents are used to launder fabrics that are then dried by line drying and/or machine drying. Such fabrics may be treated with a fabric enhancer prior to and/or during drying. Such fabrics exhibit a clean appearance and have a soft feel.

TABLE IV

| | Eg. 1 | Eg. 2 | Eg. 3 |
|---|---|---|---|
| Ingredient | wt % | wt % | wt % |
| LAS (Non-sulphated anionic | 10.0 | 15.0-16.0 | 7.0 |
| surfactant) | | | |
| Mixture of alkyl sulphate surfactants | 1.5 | 1.5-2 | 1.5 |
| Cationic surfactant | 0.0-1.0 | 0.0-1.5 | 0.0-1.0 |
| Non ionic surfactant | 0.0-1.0 | 0.0-1.5 | 0.0-1.0 |
| Zeolite | 0.0-3.0 | 6.0-10.0 | 0.0-3.0 |
| Polymeric dispersing or soil release | 1.0-3.0 | 1.0-4.0 | 1.0-3.0 |
| agents | | | |
| Bleach and bleach activator | 0.0-5.0 | 4.0-6.0 | 2-3.0 |
| Silicate | 7.0-9.0 | — | 5.0-6.0 |
| Carbonate | 10.0-30.0 | 25.0-35.0 | 15.0-30.0 |
| Sulfate | 30.0-70.0 | 30.0-35.0 | 40.0-70.0 |
| Inventive Polymers 1-5 in Example I | 0.25-1.0 | 0.25-1.0 | 0.25-1.0 |

| | |
|---|---|
| Deionized water | Balance to 100 wt % |

### (B). Heavy Duty Liquid Detergents

The following heaving duty liquid detergents are made by mixing the ingredients listed below via conventional processes. Such heavy duty liquid detergents are used to launder fabrics that are then dried by line drying and/or machine drying. Such fabrics may be treated with a fabric enhancer prior to and/or during drying. Such fabrics exhibit a clean appearance and have a soft feel.

TABLE V

| Ingredients (wt %) | Eg. 4 | Eg. 5 | Eg. 6 | Eg. 7 | Eg. 8 | Eg. 9 | Eg. 10 |
|---|---|---|---|---|---|---|---|
| Alkyl ether sulfate (EO = 1-3) | 8-15 | 11-14 | 12.07 | 12.07 | 8.32 | 13.5 | 13.5 |
| Linear alkylbenzene | 0-10 | 1-6 | 1.86 | 1.66 | 5.52 | 1.5 | — |
| sulfonate | | | | | | | |
| Amine oxide | 0-2 | 0.5-1 | — | 0.75 | — | — | — |
| Alkyl ethoxylate (EO7) | 0-5 | 1-2 | 1.12 | 0.65 | 1.21 | — | 1.5 |
| Citric acid | 0.1-6 | 1-3 | 1.5-2.5 | 1.5-2.5 | 1.5-2.5 | 1.5-2.5 | 1.5-2.5 |
| Fatty acid (DTPK) | 0.5-3 | 1-1.5 | 1.21 | 1.21 | 1.21 | 1.0 | 1.0 |
| Boric acid | 0-4 | 1-3 | 1.5-2.5 | 1.5-2.5 | 1.5-2.5 | 1.5-2.5 | 1.5-2.5 |
| Polyethyleneimine | 0-3 | 0-2 | — | — | — | 0.5-1.5 | 0.5-1.5 |
| ethoxylate/propoxylate | | | | | | | |
| Hexamethylene diamine | 0-1 | 0-0.5 | 0-0.5 | 0-0.5 | 0-0.5 | — | — |
| (ethoxylated, quaternized, | | | | | | | |
| sulfated) | | | | | | | |
| DTPA | 0-0.5 | 0.1-0.3 | 0.1-0.3 | 0.1-0.3 | 0.1-0.3 | 0.1-0.3 | 0.1-0.3 |
| Fluorescent whitening agent | 0-0.1 | 0.02-0.1 | 0.05-0.1 | 0.05-0.1 | 0.05-0.1 | 0.05-0.1 | 0.05-0.1 |
| Propylene glycol | 0-3 | 1-2 | 1-2 | 1-2 | 1-2 | 1-2 | 1-2 |
| NaOH | 0-5 | 1-4 | 2-3 | 2-3 | 3-3.5 | 2.5-3 | 2.5-3 |
| Inventive Polymers 1-5 of | 0.05-1 | 0.1-0.5 | 0.125-0.25 | 0.125-0.25 | 0.1-0.5 | 0.5 | 0.5 |
| Example I | | | | | | | |
| Water and miscellaneous | Balance | Balance | Balance | Balance | Balance | Balance | Balance |
| Total | 100 | 100 | 100 | 100 | 100 | 100 | 100 |

TABLE VI

| Ingredient (wt %) | Eg. 11 | Eg. 12 | Eg. 13 | Eg. 14 | Eg. 15 | Eg. 16 | Eg. 17 | Eg. 18 |
|---|---|---|---|---|---|---|---|---|
| Alkyl ether sulfate | 0-12 | 2-10 | 2.1 | 9 | 12 | 8.0 | 2.9 | — |
| (EO = 1-3) | | | | | | | | |
| Linear alkylbenzene | 0-20 | 1-3 | 2.0 | — | 2.8 | 6.2 | 5.6 | 17.7 |
| sulfonate | | | | | | | | |
| Alkyl ethoxylate (EO = | 3-15 | 6-12 | 12.0 | 6 | 4.9 | 7.7 | 7.1 | — |
| 7 or 9) | | | | | | | | |
| Alkyl ethoxylate | 0-55 | — | — | — | — | — | — | 51.4 |
| (C12, 14, 16 EO20-25 | | | | | | | | |
| PO1-2) | | | | | | | | |
| Citric acid | 0.5-6 | 1-3 | 1-3 | 1-3 | — | 1.6 | 1.9 | — |
| Fatty acids | 0-4 | 0.5-2 | 1.0 | 1.0 | 1.2 | 1.9 | 1.0 | 3.5 |
| Boric acid | 0-5 | 1-3 | 1-3 | 1-3 | — | — | — | — |
| Calcium and sodium | — | — | — | — | 2.2 | — | — | — |
| formate | | | | | | | | |
| Glycerine | — | — | — | — | 2.0 | — | — | — |
| Polyethyleneimine | 0-3 | 0.5-2 | 0.5-2 | 0.5-2 | — | — | — | — |
| ethoxylate/propoxylate | | | | | | | | |
| Hexamethylene diamine | 0-1 | 0-0.5 | 0-0.5 | 0-0.5 | — | — | — | — |
| (ethoxylated,quaternized, | | | | | | | | |
| sulfated) | | | | | | | | |
| Polyacrylate | 0-2 | — | — | — | 1.0 | 0.1 | 0.1 | — |
| DTPA | 0-0.5 | 0.1-0.2 | 0.1-0.2 | 0.1-0.2 | — | — | — | 0.06 |
| Diethylene triamine | 0-0.5 | — | — | — | 0.25 | — | — | — |
| penta methylene | | | | | | | | |
| phosphonic acid | | | | | | | | |
| Fluorescent whitening | 0-0.2 | 0.05-0.1 | 0.05-0.1 | 0.05-0.1 | — | 0.06 | 0.17 | — |
| agent | | | | | | | | |
| Propylene glycol | 0-5 | 1-2 | 1-2 | 1-2 | — | — | — | — |
| Butyl carbitol | 0-15 | — | — | — | — | — | — | 11.4 |
| Ethanolamine | 0-5 | — | — | — | — | 1.2 | — | 4.8 |
| NaOH | 0-5 | 0-5 | 2.0 | 2.8 | 1.6 | 1.9 | 1.4 | — |
| Inventive Polymers 1-5 | 0.05-1 | 0.1-0.5 | 0.5 | 0.5 | 0.1-0.5 | 0.1-0.5 | 0.1-0.5 | 0.1-0.5 |
| of Example I | | | | | | | | |
| Water and miscellaneous | Balance | Balance | Balance | Balance | Balance | Balance | Balance | Balance |
| Total | 100 | 100 | 100 | 100 | 100 | 100 | 100 | 100 |

TABLE VII

| Ingredient (wt %) | Eg. 19 | Eg. 20 | Eg. 21 | Eg. 22 | Eg. 23 |
|---|---|---|---|---|---|
| Alkyl ether sulfate (EO = 1-3) | 0-9 | 0-3 | 1.5 | 1.5 | — |
| Linear alkylbenzene sulfonate | 5-20 | 10-15 | 12.0 | 13.5 | 13.5 |
| Alkyl ethoxylate (EO = 7 or 9) | 0-9 | 0-6 | 1.5 | — | 1.5 |
| Citric acid | 0.5-6 | 1-3 | 1-3 | 1-3 | 1-3 |
| Fatty acid | 0-3 | 0.5-2 | 1.0 | 1.0 | 1.0 |
| Boric acid | 0-5 | 1-3 | 1-3 | 1-3 | 1-3 |
| Polyethyleneimine | 0-2 | 0.5-1.5 | 0.5-1.5 | 0.5-1.5 | 0.5-1.5 |
| ethoxylate/propoxylate | | | | | |
| Hexamethylene diamine | 0-1 | 0.3-0.5 | 0.3-0.5 | 0.3-0.5 | 0.3-0.5 |
| (ethoxylated, quaternized, | | | | | |
| sulfated) | | | | | |
| DTPA | 0-0.5 | 0.1-0.25 | 0.1-0.25 | 0.1-0.25 | 0.1-0.25 |
| Fluorescent whitening agent | 0-0.2 | 0.05-0.1 | 0.05-0.1 | 0.05-0.1 | 0.05-0.1 |
| Propylene glycol | 0-12 | 4-10 | 4-10 | 4-10 | 4-10 |
| NaOH | 0-5 | 1-4 | 1-4 | 1-4 | 1-4 |
| Inventive Polymers 1-5 of | 0.05-1 | 0.1-0.5 | 0.5 | 0.5 | 0.25 |
| Example I | | | | | |
| Water and miscellaneous | Balance | Balance | Balance | Balance | Balance |
| Total | 100 | 100 | 100 | 100 | 100 |

TABLE VIII

| Ingredient (wt %) | Eg. 24 | Eg. 25 | Eg. 26 | Eg. 27 | Eg. 28 | Eg. 29 |
|---|---|---|---|---|---|---|
| Alkyl ether sulfate (EO = 1-3) | 8-10 | 6-8 | 5-7 | 2-4 | 2-3 | 1-1.5 |
| Linear alkylbenzene sulfonate | 6-7 | 8-10 | 5-7 | 8-10 | 6-8 | 9-11 |
| Amine Oxide | — | — | 0.3-0.7 | — | — | — |
| Alkyl ethoxylate (EO = 7or 9) | 1-1.5 | 0.5-1 | 4-5 | 3-5 | 5-6 | 6-7 |
| Citric acid | 1.5-2 | 1-2 | 1-1.5 | 1.5-2.5 | 2.5-3 | 3-3.5 |
| Fatty acid | 1-1.5 | 1-1.5 | 1-1.5 | 1-1.5 | 3-3.5 | 2-3 |
| Enzymes | 0.5-1 | — | 0.2-0.5 | — | 0.3-0.5 | 0.5-1 |
| Boric acid | 1.5-2.5 | 1.5-2.5 | 1.5-2.5 | 1.5-2.5 | 1-1.5 | — |
| Calcium and sodium formate | — | — | — | — | — | 0.1-0.3 |
| Hexamethylene diamine | 0.25- | 0.25- | 0.25- | — | — | 0.25- |
| (ethoxylated, quaternized, | 0.75 | 0.75 | 0.75 | | | 0.75 |
| sulfated) | | | | | | |
| Polyethyleneimine | — | — | 0.5-2 | 0.5-2 | 0.5-2 | — |
| ethoxylate/propoxylate | | | | | | |
| Ethyleneglycol/Vinylacetate | — | — | — | — | — | 1-1.5 |
| copolymer | | | | | | |
| DTPA | 0.1-0.5 | 0.1-0.2 | 0.1-0.2 | 0.1-0.2 | — | — |
| Diethylene triamine penta | — | — | — | — | 0.2-0.5 | 0.2-0.5 |
| methylene phosphonic acid | | | | | | |
| Fluorescent whitening agent | 0.05-0.1 | 0.05-0.1 | 0.05-0.1 | 0.05-0.1 | 0.05-0.1 | 0.05-0.1 |
| Ethanol/Propylene glycol | 2-3 | 2-3 | 2-3 | 1-2 | 1-2 | 1-3 |
| Ethanolamine | — | — | — | — | 0.75-1 | 0.2-0.5 |
| NaOH | 3-4 | 2-3 | 2-3 | 2.5-4 | 2.5-4 | — |
| NaCS | — | — | 0.1-0.5 | — | 2-3 | 1-2 |
| Inventive Polymers 1-5 of | 0.05-1 | 0.1-0.5 | 0.5 | 0.5 | 0.1-0.5 | 0.25 |
| Example I | | | | | | |
| Water and miscellaneous | Balance | Balance | Balance | Balance | Balance | Balance |
| Total | 100 | 100 | 100 | 100 | 100 | 100 |

### (C). Fabric Enhancers

Fabric enhancer compositions may be prepared by mixing together the ingredients listed in the proportions shown:

TABLE IX

| | Eg. 30 | Eg. 31 | Eg. 32 | Eg. 33 | Eg. 34 |
|---|---|---|---|---|---|
| Ingredient | wt % | | | | |
| FSA | 12.0 | 21.0 | 18.0 | 14.0 | 12.0 |
| Low Mw alcohol | 1.95 | 3.0 | 3.0 | 2.28 | 2.28 |
| Rheology modifier | 1.25 | — | 0.2 | — | 0.2 |
| Perfume oil | 1.50 | 2.3 | 2.0 | 1.50 | 1.50 |
| Perfume encapsulation | 0.6 | 0.3 | 0.4 | — | 0.15 |
| Phase Stabilizing | 0.25 | — | — | 0.142 | 0.25 |
| Polymer | | | | | |
| Calcium Chloride | 0.10 | 0.12 | 0.1 | 0.45 | 0.55 |
| DTPA | 0.005 | 0.005 | 0.005 | 0.005 | 0.005 |
| Preservative (ppm) | 5 ppm | | | | |
| Antifoam | 0.015 | 0.15 | 0.11 | 0.011 | 0.011 |
| Polyethylene imines | 0.15 | 0.05 | — | 0.1 | — |
| Inventive Polymers 1-5 | 1.56 | 2.6 | 5.25 | 5.25 | 4.2 |
| of Example I | | | | | |
| Stabilizing Surfactant | — | — | 0.5 | 0.2 | 0.2 |
| Organosiloxane polymer | 5 | — | — | — | — |
| Amino-functional | — | — | — | — | 5 |
| silicone | | | | | |
| Dye (ppm) | 40 | 11 | 30 | 40 | 40 |
| Ammonium Chloride | 0.10 | 0.12 | 0.12 | 0.10 | 0.10 |
| HCl | 0.010 | 0.01 | 0.10 | 0.010 | 0.010 |

| | |
|---|---|
| Deionized Water | Balance to 100 wt % |

### (D). Rinse Additive

Rinse additive compositions may be prepared by mixing together the ingredients listed in the proportions shown:

TABLE X

| Ingredient | % wt |
|---|---|
| Structure material | 0-1.0 |
| Inventive polymers 1-5 of | 0.01-15 |
| Example I | |
| Dye | 0-0.01 |
| Perfume oil | 0-1.0 |
| Preservative | 0-0.2 |
| Deionized Water | Balance to 100 wt % |

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for improving sudsing profile of a laundry detergent composition with a cationic polymer, wherein said cationic polymer is present in the laundry detergent composition at an amount from 0.01 wt % to 15 wt %, and wherein said cationic polymer comprises:
(i) from 35 mol % to 85 mol % of a first, nonionic structural unit derived from (meth)acrylamide (AAm);
(ii) from 10 mol % to 65 mol % of a second, cationic structural unit; and
(iii) from 0.1 mol % to 35 mol % of a third, anionic structural unit that is derived from (meth)acrylic acid (AA) or anhydride thereof,
wherein the total mol % of (i)-(iii) adds up to 100 mol %, wherein the molar ratio of (ii) to (iii) is greater than 1, and wherein said cationic polymer is characterized by a weight average molecular weight (Mw) ranging from 1,000 to 300,000 Daltons.

2. The method of claim 1, wherein the laundry detergent composition is characterized by a pH of equal to or greater than 7, and wherein the laundry detergent composition further comprises from 1 wt % to 50 wt % of one or more anionic surfactants selected from the group consisting of C₁₀-C₂₀ linear alkyl benzene sulphonates, C₁₀-C₂₀ linear or branched alkylalkoxy sulfates having a weight average degree of alkoxylation ranging from 0.1 to 5.0, C₁₀-C₂₀ linear or branched alkyl sulfates, C₁₀-C₂₀ linear or branched alkyl ester sulfates, C₁₀-C₂₀ linear or branched alkyl sulphonates, C₁₀-C₂₀ linear or branched alkyl ester sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof.

3. The method of claim 1, wherein the second, cationic structural unit of the cationic polymer is derived from a monomer selected from the group consisting of diallyl dimethyl ammonium salts (DADMAS), N,N-dimethyl aminoethyl acrylate, N,N-dimethyl aminoethyl methacrylate (DMAM), [2-(methacryloylamino)ethyl]tri-methylammonium salts, N,N-dimethylaminopropyl acrylamide (DMAPA), N,N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and combinations thereof.

4. The method according to claim 3, wherein said second, cationic structural unit is preferably derived from diallyl dimethyl ammonium salts (DADMAS).

5. The method according to claim 1, wherein the molar ratio of structural units (ii) to (iii) of the cationic polymer ranges from 1.5 to 30, preferably from 2 to 20, and more preferably from 3 to 10.

6. The method according to claim 1, wherein the weight average molecular weight (Mw) of the cationic polymer ranges from 10,000 to 250,000 Daltons, and preferably from 20,000 to 200,000 Daltons.

7. The method according to claim 1, wherein the cationic polymer comprises:
(i) from 55 mol % to 85 mol % of the first, nonionic structural unit;
(ii) from 15 mol % to 60 mol % of the second, cationic structural unit; and
(iii) from 0.2 mol % to 20 mol % of the third, anionic structural unit.

8. The method according to claim 1, wherein said laundry detergent composition is a designated hand-washing laundry detergent product.

9. The method according to claim 1, wherein said laundry detergent composition has an improved sudsing profile characterized by: (1) a Wash Suds Index (WSI) of more than 90%; and (2) a Rinse Suds Index (RSI) of less than 50%, as determined by the Sudsing Profile Test described herein.

10. A liquid laundry detergent composition characterized by a pH of equal to or greater than 7, which comprises:
(A) from 1 wt % to 50 wt % of one or more anionic surfactants selected from the group consisting of C₁₀-C₂₀ linear alkyl benzene sulphonates, C₁₀-C₂₀ linear or branched alkylalkoxy sulfates having a weight average degree of alkoxylation ranging from 0.1 to 5.0, C₁₀-C₂₀ linear or branched alkyl sulfates, C₁₀-C₂₀ linear or branched alkyl ester sulfates, C₁₀-C₂₀ linear or branched alkyl sulphonates, C₁₀-C₂₀ linear or branched alkyl ester sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof; and
(B) from 0.01 wt % to 15 wt % of a cationic polymer comprising:
(i) from 35 mol % to 85 mol % of a first, nonionic structural unit derived from (meth)acrylamide (AAm);
(ii) from 10 mol % to 65 mol % of a second, cationic structural unit; and
(iii) from 0.1 mol % to 35 mol % of a third, anionic structural unit that is derived from (meth)acrylic acid (AA) or anhydride thereof,
wherein the total mol % of (i)-(iii) adds up to 100 mol %, wherein the molar ratio of (ii) to (iii) is greater than 1, and wherein said cationic polymer is characterized by a weight average molecular weight (Mw) ranging from 1,000 to 300,000 Daltons.

11. The liquid laundry detergent composition of claim 10, wherein the second, cationic structural unit of the cationic polymer is derived from a monomer selected from the group consisting of diallyl dimethyl ammonium salts (DADMAS), N,N-dimethyl aminoethyl acrylate, N,N-dimethyl aminoethyl methacrylate (DMAM), [2-(methacryloylamino)ethyl]tri-methylammonium salts, N,N-dimethylaminopropyl acrylamide (DMAPA), N,N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and combinations thereof.

12. The liquid laundry detergent composition of claim 11, wherein said second, cationic structural unit is derived from diallyl dimethyl ammonium chloride (DADMAC).

13. The liquid detergent composition of claim 10, wherein the molar ratio of structural units (ii) to (iii) of the cationic polymer ranges from 1.5 to 30.

14. The liquid detergent composition of claim 13, wherein the molar ratio of structural units (ii) to (iii) of the cationic polymer ranges from 2 to 10.

15. The liquid detergent composition according to claim 10, wherein the weight average molecular weight (Mw) of the cationic polymer ranges from 10,000 to 250,000 Daltons.

16. The liquid detergent composition according to claim 15, wherein the weight average molecular weight (Mw) of the cationic polymer ranges from 20,000 to 200,000 Daltons.

17. The liquid detergent composition according to claim 10, wherein the cationic polymer comprises:
(i) from 55 mol % to 85 mol %, and preferably from 65 mol % to 80 mol %, of the first, nonionic structural unit;
(ii) from 15 mol % to 60 mol %, and preferably from 15 mol % to 30 mol %, of the second, cationic structural unit; and
(iii) from 0.2 mol % to 20 mol %, preferably from 0.5 mol % to 10 mol %, and more preferably from 1 mol % to 5 mol %, of the third, anionic structural unit.

18. The liquid detergent composition according to claim 17, wherein the cationic polymer comprises:
(i) from 65 mol % to 80 mol % of the first, nonionic structural unit;
(ii) from 15 mol % to 30 mol % of the second, cationic structural unit; and
(iii) from 0.5 mol % to 10 mol % of the third, anionic structural unit.

19. The liquid detergent composition according to claim 10, which is a designated hand-washing laundry detergent product.

20. The liquid detergent composition according to claim 10, which is further characterized by an improved sudsing profile characterized by: (1) a Wash Suds Index (WSI) of more than 90%; and (2) a Rinse Suds Index (RSI) of less than 50%, as determined by the Sudsing Profile Test described herein.
